(19) United States
(12) Patent Application Publication
(10) Pub. No.: US 2007/0088839 A1
(43) Pub. Date: Apr. 19, 2007

(54) Local time related presence automation and session control

(75) Inventor: John H. Yoakum, Cary, NC (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/253,941

(22) Filed: Oct. 19, 2005

(51) Int. Cl. G06F 15/173; G06F 15/16

(52) U.S. Cl. 709/228; 709/224

(57) ABSTRACT

The present invention provides a technique for using local time information associated with a monitored person when determining presence information and controlling communication sessions associated with the monitored person. The local time information is directly or indirectly related to the actual time or a time zone for the location at which the monitored person is located. In a presence system, the local time information for the monitored person is obtained and used to generate presence information. The presence information may be or include information related to the actual time or the time zone for the monitored person. The presence information may also be based on state information provided by monitored entities associated with the monitored person. In a session control system, sessions associated with the monitored person may be controlled in virtually any manner and may also be associated with other communication sessions based on the local time information.

### FIELD OF THE INVENTION

The present invention relates to providing presence information and controlling communication sessions in light of the local time at a user's current location.

### BACKGROUND OF THE INVENTION

Given the rapid expansion of mobile communications along with the pervasiveness of email and instant messaging, determining the right method or time to contact someone often proves difficult. Many people are associated with numerous telephone numbers associated with fixed and mobile terminals, email addresses, instant messaging identifiers, and the like. Trying to contact such people often leads to leaving one or more voicemails and perhaps sending email or instant messaging messages prior to making contact. Further, trading numerous messages or voicemails prior to finally connecting with one another is commonplace.

Presence systems have been developed to address the difficulty in determining if someone is available to communicate, and perhaps how best to communicate with that person when she is available. In general, presence systems monitor state information from one or more devices or networks associated with a particular person, and process the state information to create presence information bearing on the relative availability of that particular person. The presence information is then sent to those subscribers interested in knowing the relative availability of the particular person. The state information generally bears on a person's physical presence or activity with respect to a certain device.

A person's relative availability to receive communications may change based on the local time at her present location. As a person moves from one time zone to another or when a caller doesn't know where the person being called is located, the local time of the person takes on a more significant role in determining the person's relative availability to receive communications. For example, if a person has traveled to China from the eastern United States, the person may not want to receive communications after local work hours or during the night. Further, those trying to get in touch with the person may not be aware of the local time for the person. The person may also want incoming calls or other communication attempts redirected or handled in a specified manner, depending on the local time for the person. Incoming calls during work hours may need to be directed to an office telephone, while emergency calls at any time should be directed to the person's work telephone during the day and either the hotel or mobile telephone during the night.

Unfortunately, existing presence systems are generally focused on a user's interaction with various devices and do not consider the local time for the user in determining availability. Accordingly, there is a further need for a cost effective and efficient technique to allow a presence system to automatically obtain information bearing on the local time associated with a person and provide presence information to subscribers in light of the local time for the person. There is yet a further need to control communication sessions based on information bearing on the local time associated with a person.

### SUMMARY OF THE INVENTION

The present invention provides a technique for using local time information associated with a monitored person when determining presence information and controlling communication sessions associated with the monitored person. The local time information is directly or indirectly related to the actual time or a time zone for the location at which the monitored person is located. In a presence system, the local time information for the monitored person is obtained and used to generate presence information. The presence information may be or include information related to the actual time or the time zone for the monitored person. The presence information may also be based on state information provided by monitored entities associated with the monitored person. In a session control system, sessions associated with the monitored person may be controlled in virtually any manner and may also be associated with other communication sessions based on the local time information.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 illustrates a process flow for retrieving state information and providing presence information according to one embodiment of the present invention.

FIG. 3 illustrates a process flow for retrieving local time information according to one embodiment of the present invention.

FIG. 4 is a flow diagram outlining a provisioning process according to one embodiment of the present invention.

FIG. 5 is a flow diagram outlining the overall operation of a presence system according to one embodiment of the present invention.

FIG. 6 is a flow diagram outlining the processing of state information or local time information according to one embodiment of the present invention.

FIG. 7 is a flow diagram outlining overall operation of a service node to control communication sessions based on local time information according to one embodiment of the present invention.

FIG. 8 is a block representation of a presence server according to one embodiment of the present invention.

FIG. 9 is a block representation of a service node according to one embodiment of the present invention.

FIG. 10 is a block representation of a mobile terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

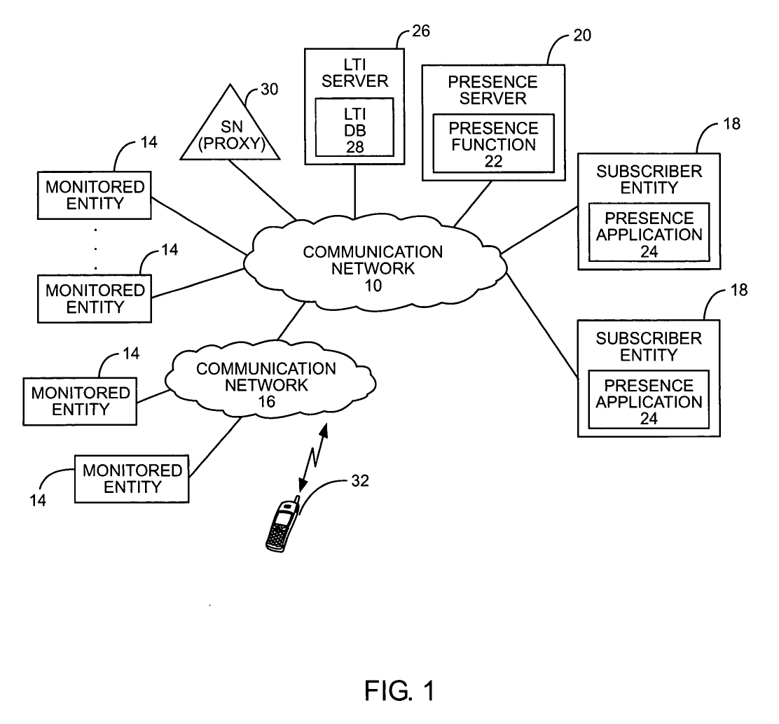

The present invention addresses the shortcomings of existing presence systems and session control entities by providing an effective and efficient technique for using local time information associated with a monitored person when determining presence information and controlling communication sessions associated with the monitored person. The local time information is directly or indirectly related to the actual time or time zone for the location at which the monitored person is located. An exemplary presence and communication network according to one embodiment of the present invention is illustrated in FIG. 1.

A communication network 10 is configured to provide a presence system as well as support communications with any number of monitored entities 14, directly or indirectly through another communication network 16, as well as supporting communications with various subscriber entities 18 to which presence information is delivered. The monitored entities 14 are generally those with which a monitored person will directly or indirectly interact, and will provide state information bearing on the person's activity, presence, or location. A presence server 20 is provided and includes a presence function 22, which processes the state information to create presence information to provide to the subscriber entities 18. The subscriber entities 18 may include presence applications 24, which process the presence information and operate to control the associated subscriber entity 18 as necessary to provide presence alerts to the subscriber based on the presence information. Accordingly, as state information for a monitored person changes, up-to-date presence information is provided to the subscriber entities 18. The presence information will aid the subscribers associated with subscriber entities 18 in deciding when or how to communicate with the monitored person.

In an effort to make presence information more accurate and helpful, the present invention keeps track of local time information associated with the monitored person and used the local time information when generating presence information for delivery to the subscriber entities 18. The local time information bears on the relative local time at the monitored person's current location. The local time information may be or bear on the actual local time, or the time zone at the monitored person's location. The times or time zones may be represented by absolute values, a time shift from a reference location, or the like. The local time information is any information from which the relative local time at the user's current location can be derived.

The local time information may be directly or indirectly retrieved from any source, including one or more of the monitored entities 14, the communication network 16, communication network 10, or the user. The local time information may be retrieved directly or indirectly by a local time information (LTI) server 26 and stored in an LTI database (DB) 28. Alternatively, the LTI database 28 may be implemented in the presence server 20 or a service node 30. The service node 30 represents any session control device capable of assisting in establishing, controlling, or ending a communication session associated with the monitored person. As illustrated, the service node 30 acts as a proxy, such as a session initiation protocol (SIP) proxy, for a mobile terminal 32 of the monitored person. The mobile terminal 32 may be considered a monitored entity, which is also capable of providing state information, local time information, or both.

In addition to handling state and presence information, the primary responsibility of the communication network 10 is to facilitate communications among various communication terminals, including the mobile terminal 32, or between a communication terminal and another network entity, such as an application server (not shown). Notably, the monitored entities 14 and the subscriber entities 18 may take the form of communication terminals, which may be mobile telephones, personal digital assistants, circuit-switched or packet-based telephones, personal computers, or other communication devices. As described further below, the mobile terminal 32 is capable of providing wireless communications with the communication network 10 through an appropriate access network or access point using virtually any type of wireless communications, including cellular and wireless local area network techniques. Notably, the communication terminals used for gathering local time information need not be wireless, but can be wired.

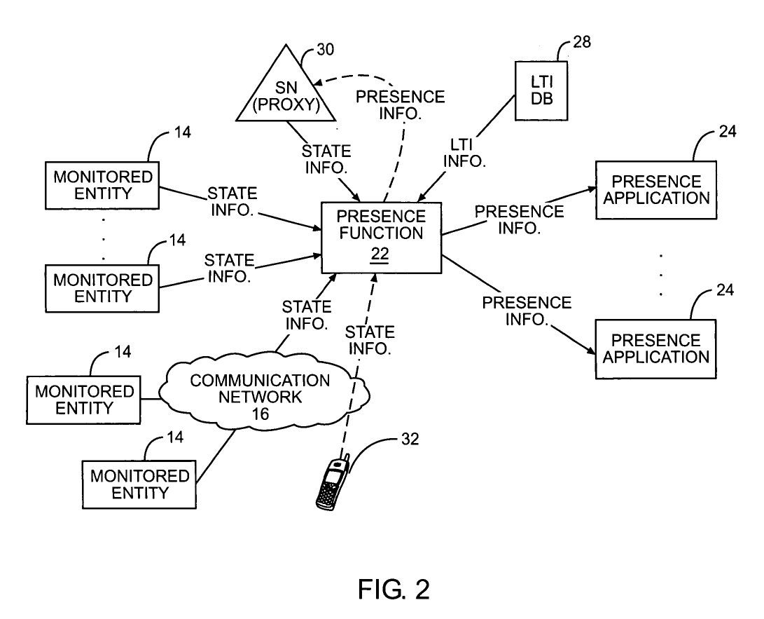

With reference to FIG. 2, the basic flow for presence processing is illustrated. In operation, the presence function 22 will obtain local time information from an internal or external LTI database 28. In addition, the monitored entities 14 may recognize certain states or state changes in light of a monitored person's interaction, use, or physical presence. The monitored entities 14, which may include the mobile terminal 32 and the service node 30, may provide state information to the presence function 22 as locations or states change, on a periodic basis, or upon request from the presence function 22. The communication network 16 may also generate the state information in light of certain interactions with the monitored entities 14, or may simply pass state information from the monitored entities 14 to the presence function 22.

Regardless of how the state information or the local time information is received, the state information for a monitored person is processed in light of defined presence rules using any available state information, local time information, or a combination thereof to create presence information for the monitored person. The presence information may be or include local time information, such as the time zone, local time, or the like where the monitored person is located. The presence information is then sent to subscribing presence applications 24. The presence information may be provided to the presence applications 24 when the presence information changes, on a periodic basis, or upon request from the presence application 24.

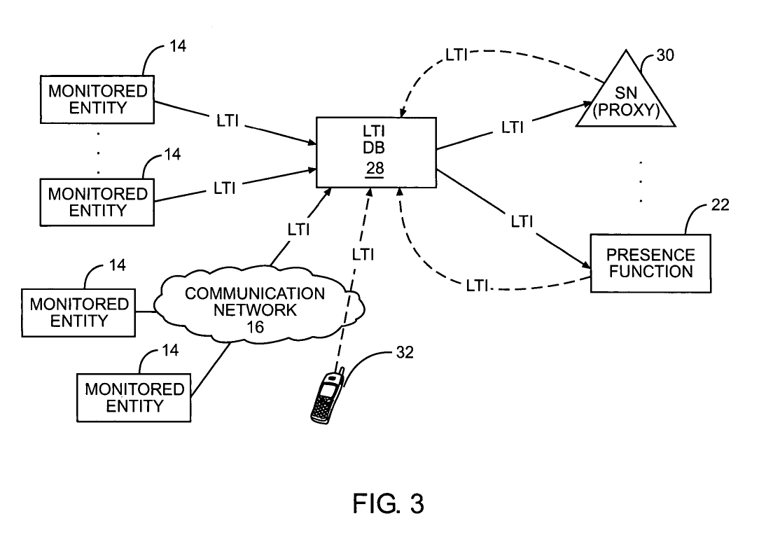

With reference to FIG. 3, the basic flow for retrieving local time information is illustrated. The LTI database 28 may be provided by a separate entity such as the LTI server 26 or integrated with presence server 20, presence function 22, service node 30, or other network entity. Regardless of location, the LTI database 28 will directly or indirectly receive local time information associated with the monitored person and make the local time information available to the presence function 22, service node 30, or other network entity. The local time information received by the LTI database 28 may be provided by the monitored entities 14, including the mobile terminal 32, the communication network 16, the presence function 24, the service node 30, or other entity in a direct or indirect fashion.

For example, if the communication network 16 is a cellular network, the base station or mobile switching center (not shown) supporting communications with the mobile terminal 32 may recognize such support and send the local time information to an entity providing the LTI database 28. In this configuration, the mobile terminal 32 would not need to be aware of the actions taken by the communication network 16. In another embodiment, the mobile terminal 32 could be configured to provide local time information to the entity providing the LTI database 28. The monitored entities 14 could also provide local time information upon recognizing interaction by the monitored person. The service node 30 could provide local time information based on controlling communication session for the monitored entity. Accordingly, local time information could be initially provided to the LTI database 28 by the service node 30 for use by the presence function 22, and vice versa.

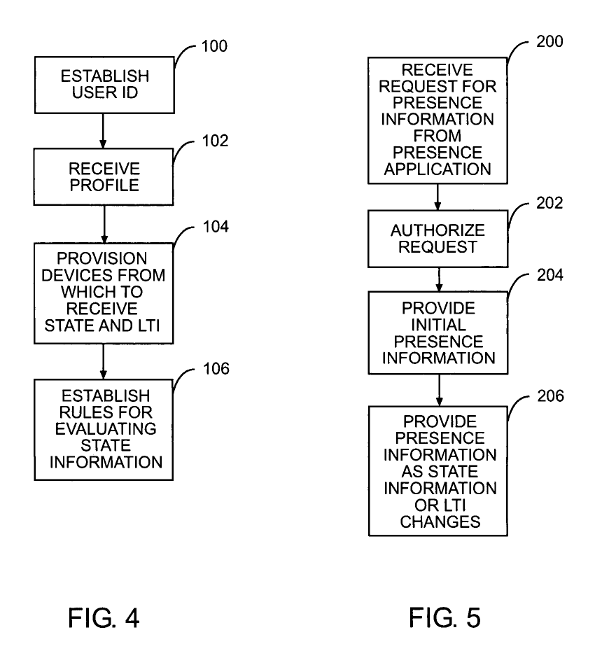

Turning now to FIGS. 4 through 6, flow diagrams are provided for various aspects of the presence operation. An exemplary process for initializing a presence function 22 of the presence server 20 to retrieve state information and disseminate presence information is outlined in FIG. 4. Initially, the monitored person may establish an identification for the presence service provided by the integrated presence server 20 (step 100). The presence server 20 will then receive a profile for the monitored person (step 102). Based on the profile, the presence server 20 is provisioned to receive state information and local time information from the monitored entities 14, mobile terminal 28, presence server 20, service node 30, or other entity (step 104). Preferably, the presence function 22 is configured to receive the state information and the local time information from the appropriate entities, which are configured to provide the state information and the local time information.

Next, the rules for evaluating the state information and the local time information are established at the presence function 22 based on the profile (step 106). At this point, the presence function 22 is configured for the monitored person. The rules typically define how to evaluate the state information and local time information to generate the resultant presence information. The monitored person may use the profile to establish rules to control how she should be contacted based on the state of one or more associated devices and their relative local time, time zone, or the like.

Those skilled in the art will recognize limitless variations in profile and rule construction for evaluating state and local time information and generating presence information to send to subscriber entities 18. Further, any combination of current and past state information may be used to determine the presence information. For example, the presence information may be or be based solely on the local time information. Alternatively, the presence information may be based on state information, wherein the local time or time zone information is provided along with a presence portrait corresponding to the state information alone.

Preferably, the presence information is automatically updated, if necessary, when state changes are detected. The presence information may also be updated with local time information changes in a manner indicating the user has moved from one time zone or location to another. Depending on the presence rules, a state change for a given monitored entity 14 or a change in local time information may or may not impact the presence information. If the presence information does not change, then there may not be a need to provide an update to the subscriber entities 18.

FIG. 5 provides an exemplary process for subscribing to presence updates for a monitored person through the presence server 20. Initially, a subscriber, via a subscriber entity 18, will send a request to subscribe to the presence server 20. The presence function 22 will receive the request for presence information from the subscriber entity 18 (step 200). The presence function 22 will authorize the request (step 202), and, if authorized, provide initial presence information to the subscriber entity 18 (step 204). The initial presence information may be default presence information or that based on current state information as evaluated by the rules. Once subscribed, the presence server 20 will provide presence information to the subscriber entities 18 as state information for the monitored entities 14 or local time information changes in a manner warranting a presence update (step 206).

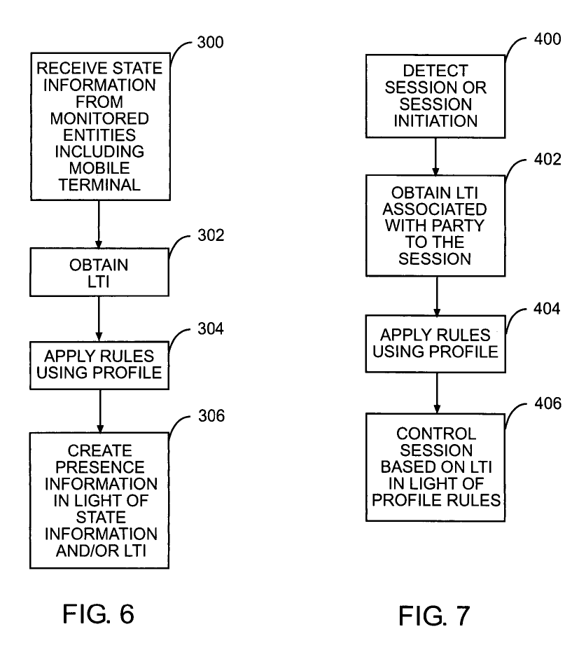

FIG. 6 illustrates an exemplary process for evaluating state information from the monitored entities 14, including the mobile terminal 32. The presence server 20 continuously receives state information from the applicable monitored entities 14 and local time information from the LTI database 28 (steps 300 and 302) and applies the rules for the monitored person based on her profile (step 304). Notably, the subscriber entities 18 or subscriber associated therewith can also provide a profile to configure or otherwise filter delivery of presence information for the monitored person. Finally, the presence application 22 will evaluate the state changes and local time information to create presence information, if necessary, to send to the subscriber entities 18 (step 306). If the local time information is old or hasn't been updated recently, the last known local time information can be used for creating the presence information. The local time information may be or may be included in the presence information. In this instance, the last known time zone may be more appropriate than an arbitrary time. Further, the local time information may be displayed to a subscriber and be provided separately from or as part of the presence information.

Accordingly, one embodiment of the present invention automatically receives state information, local time information, or a combination thereof and evaluates the state and local time information in to determine the relative availability of the monitored person for communications. Those skilled in the art will recognize that manually provided state and local time information may be used in combination with that initiated from naturally occurring interactions, as well as that influenced by the monitored person being in a specific location or type of location.

In another embodiment of the present invention, the service node 30 is used as a proxy or other session control device for the mobile terminal 32. Those skilled in the art will recognize the numerous ways in which the service node 30 can affect a communication session. For example, the service node 30 may play a role in initiating, establishing, controlling, redirecting, or ending a communication session as well as associating the communication session with another communication session. Through such control, both state information and local time information may be determined and provided to the LTI database 28. The service node 30 may also be able to determine whether or not it is appropriate to communicate with a party to the communication session in light of the local time information. Control of the communication session may be based on the relative appropriateness of the communication session. Further, corresponding notification messages may be sent to parties attempting to initiate a communication session when communications are either appropriate or inappropriate.

Although many communication protocols may be used to facilitate communications, as well as deliver state, local time, and presence information between the various devices, the Session Initiation Protocol (SIP) or the SIP for Instant Messaging and Presence Leveraging Extensions (SIMPLE) protocol is implemented in one embodiment of the present invention. The specification for SIP is provided in the Internet Engineering Task Force's RFC 3261: Session Initiation Protocol, which is incorporated herein by reference in its entirety. SIP messages may be used transfer local time information as well as deliver state information to the presence server 20 and deliver presence information to the subscriber entities 18.

FIG. 7 illustrates an exemplary process for controlling a communication session in light of local time information. Initially, the service node 30 will detect a communication session or initiation of a communication session (step 400). The service node 30 will obtain the local time information associated with a party to the session (step 402) and apply predefined rules provided by a profile for the party to the session (step 404). In light of the profile, the communication session is controlled based on the local time information.

From the above, local time information can be used by presence systems and session control entities to provide enhanced services. In many instances, conflicting local time information may be received from different devices. For example, the monitored person's assistant may need to access the monitored person's work computer in the United States while the monitored person is in China. While in China, the cellular network supporting the mobile terminal 32 may be providing periodic local time information to the LTI database 28. In this instance, the LTI database 28, service node 30, or presence server 20 may be configured to select the local time information deemed to be most accurate. The selection may be based on a user or service provider profile. For example, the selection may be based on recent activity, preset provisioning, or a defined priority.

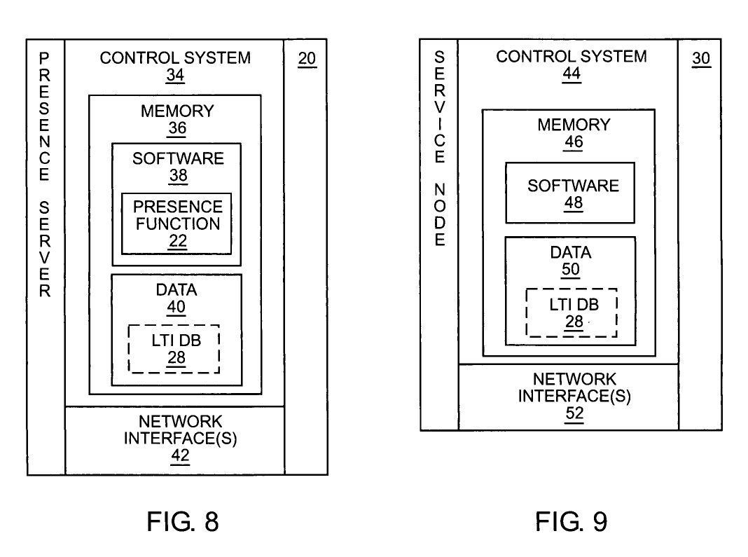

With reference to FIG. 8, a block representation of a presence server 20 is illustrated as having a control system 34 with sufficient memory 36 for the requisite software 38 and data 40 to operate as described above. The presence function 22 may be implemented in the software 38, and the LTI database 28 may be kept in the data 40. The control system 34 may also be associated with one or more network interfaces 42 to facilitate communications with the various monitored entities 14 and subscriber entities 18, as well as any other network entity.

With reference to FIG. 9, a block representation of a service node 30 is illustrated. The service node 30 will include a control system 44 having sufficient memory 46 for the requisite software 48 and data 50 to operate as described above. The LTI database 28 may be kept in the data 50 of the service node 30, in one embodiment. The control system 44 may also be associated with one or more network interfaces 52 to facilitate communications with various network entities.

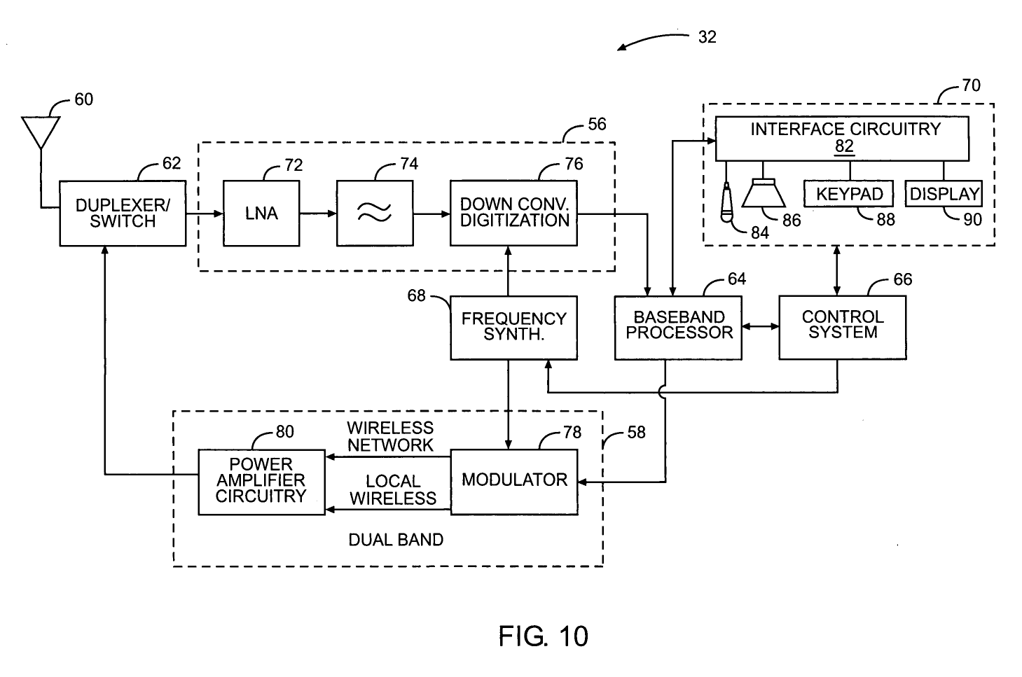

The basic architecture of the mobile terminal 32 is represented in FIG. 10. In the illustrated embodiment, the mobile terminal 32 may include a receiver front end 56, a radio frequency transmitter section 58, an antenna 60, a duplexer or switch 62, a baseband processor 64, a control system 66, a frequency synthesizer 68, and an interface 70. The receiver front end 56 receives information bearing radio frequency signals from one or more remote transmitters provided by a base station. A low noise amplifier 72 amplifies the signal. A filter circuit 74 minimizes broadband interference in the received signal, while downconversion and digitization circuitry 76 downconverts the filtered, received signal to an intermediate or baseband frequency signal, which is then digitized into one or more digital streams. The receiver front end 56 typically uses one or more mixing frequencies generated by the frequency synthesizer 68. The baseband processor 64 processes the digitized received signal to extract the information or data bits conveyed in the received signal. This processing typically comprises demodulation, decoding, and error correction operations. As such, the baseband processor 64 is generally implemented in one or more digital signal processors (DSPs).

On the transmit side, the baseband processor 64 receives digitized data, which may represent voice, data, or control information, from the control system 66, which it encodes for transmission. The encoded data is output to the transmitter 58, where it is used by a modulator 78 to modulate a carrier signal that is at a desired transmit frequency. Power amplifier circuitry 80 amplifies the modulated carrier signal to a level appropriate for transmission, and delivers the amplified and modulated carrier signal to the antenna 60 through the duplexer or switch 62.

The mobile terminal 32 may be able to communicate with a local wireless or cellular network. Local wireless communications may include those used for wireless local area networks or Bluetooth communications. Accordingly, the receiver front end 56, baseband processor 64, and radio frequency transmitter section 58 cooperate to provide either a cellular interface for the cellular network or local wireless communications. These functions may be implemented using redundant circuitry, or by configuring common circuitry to operate in different modes. The configuration of the mobile terminal 32 will be dictated by economics and designer choice. Alternately, the mobile terminal 32 could have both the local wireless interface and the wireless network interface in operation at the same time and select one of the two for communication at any given time as needed.

A user may interact with the mobile terminal 32 via the interface 70, which may include interface circuitry 82 associated with a microphone 84, a speaker 86, a keypad 88, and a display 90. The interface circuitry 82 typically includes analog-to-digital converters, digital-to-analog converters, amplifiers, and the like. Additionally, it may include a voice encoder/decoder, in which case it may communicate directly with the baseband processor 64. The microphone 84 will typically convert audio input, such as the user's voice, into an electrical signal, which is then digitized and passed directly or indirectly to the baseband processor 64. Audio information encoded in the received signal is recovered by the baseband processor 64, and converted by the interface circuitry 82 into an analog signal suitable for driving the speaker 86. The keypad 88 and display 90 enable the user to interact with the mobile terminal 32, input numbers to be dialed, address book information, or the like, as well as monitor call progress information.

Those skilled in the art will recognize improvements and modifications to the preferred embodiments of the present invention. All such improvements and modifications are considered within the scope of the concepts disclosed herein and the claims that follow.

What is claimed is:

1. A method comprising:
obtaining local time information associated with a location of a monitored person;
creating presence information for the monitored person based on the local time information; and
providing the presence information to a subscribing entity.

2. The method of claim 1 further comprising receiving state information from a monitored entity and wherein creating the presence information is further based on the state information.

3. The method of claim 1 wherein the local time information is or provides sufficient information to determine a local time at the location of the monitored person and the presence information comprises the local time at the location of the monitored person, such that the subscribing entity can provide the local time to a subscriber.

4. The method of claim 1 wherein the local time information is or provides sufficient information to determine a time zone at the location of the monitored person and the presence information comprises the time zone at the location of the monitored person, such that the subscribing entity can provide the time zone to a subscriber.

5. The method of claim 1 wherein the local time information originated from a communication terminal associated with the monitored person.

6. The method of claim 1 wherein the local time information originated from an entity in a communication network supporting a communication terminal associated with the monitored person.

7. The method of claim 1 wherein the local time information is obtained from a local time information database, which is adapted to receive and store the local time information.

8. The method of claim 1 wherein different local time information is available for the monitored person, further comprising selecting one of the different local time information to be the local time information used to create the presence information based on pre-defined criteria.

9. The method of claim 1 wherein the presence information bears on a relative availability of the monitored person to receive communications.

10. The method of claim 1 wherein the local time information is last known local time information, the presence information providing the last known local time information for the monitored person to the subscribing entity.

11. A method comprising:
obtaining local time information associated with a party to a communication session; and
controlling the communication session based on the local time information.

12. The method of claim 11 further comprising detecting the communication session.

13. The method of claim 11 wherein controlling the communication session comprises redirecting the communication session from an intended destination to another destination.

14. The method of claim 11 wherein controlling the communication session comprises associating the communication session with another communication session.

15. The method of claim 11 wherein controlling the communication session comprises determining whether to allow initiation of the communication session to proceed.

16. The method of claim 11 further comprising providing a notification to a third party when communications with the party are appropriate.

17. The method of claim 16 further comprising determining when communications with the party are appropriate and inappropriate based on the local time information.

18. The method of claim 17 further comprising providing a notification to the third party when communications with the party are inappropriate.

19. A presence system comprising:
a communication interface; and
a control system associated with the communication interface and adapted to:
obtain local time information associated with a location of a monitored person;
create presence information for the monitored person based on the local time information; and
provide the presence information to a subscribing entity.

20. The presence system of claim 19 wherein the control system is further adapted to receive state information from a monitored entity and create the presence information based on the state information.
